(19) United States
(12) Patent Application Publication
(10) Pub. No.: US 2016/0294140 A1
(43) Pub. Date: Oct. 6, 2016

(54) DEVICE FOR WELDING ELECTRICAL CONDUCTORS

(71) Applicant: SCHUNK SONOSYSTEMS GMBH, Wettenberg (DE)

(72) Inventors: Stefan Trube, Wettenberg (DE); Reiner Schmidt, Lollar (DE); Sinan Koc, Mücke (DE); Peter Wagner, Wettenberg (DE); Dieter Stroh, Wettenberg (DE)

(21) Appl. No.: 15/035,374

(22) PCT Filed: Nov. 6, 2014
(86) PCT No.: PCT/EP2014/073939

§ 371 Date: May 9, 2016

(30) Foreign Application Priority Data
Nov. 11, 2013 (DE) 10 2013 222 939.9

(51) Int. Cl. H01R 43/02; B23K 20/26; B23K 20/02; B23K 20/10

(52) U.S. Cl. CPC H01R 43/0263; H01R 43/0207; B23K 20/106; B23K 20/26; B23K 20/02

(57) ABSTRACT

The invention relates to a device for welding rod-shaped electrical conductors provided with an outer insulating sheath, the device comprising a compression space for receiving two connecting regions of the conductors to be connected to each other, wherein the compression space is provided with a marking device for axial positioning of the connecting regions, the marking device comprising a radiation-emitting device defining a position mark (56, 57).

The invention relates to a device for welding rod-shaped electrical conductors provided with an outer insulating sheath and having blank regions free of the sheath at their ends, whose length is defined by an axial sheath end surface, the device comprising a compression space for receiving connecting regions of the conductors to be connected to each other, the compression space being limited in a first axial direction at two opposing sides by a working surface of a sonotrode transmitting ultrasonic vibrations in the first axial direction and by an opposing surface of an opposing electrode and in a second axial direction at two opposing sides by a limiting surface of a slider element displaceable in the second axial direction and by a limiting surface of a limiting element.

A device of the kind mentioned above is known from EP 1 765 545 A1, said device being provided with an auxiliary device supporting the formation of an overlapping arrangement of the connecting regions in the compression space in that a leading or guiding element ensures that the connecting regions overlap each other in an axial direction transverse to the longitudinal extension of the conductors with longitudinal axes of the connecting regions being aligned parallel to each other. This kind of overlapping arrangement is necessary in order to enable a reliable connection between the connecting regions after closure of the compression space by corresponding displacing motions of the surfaces limiting the compression space and subsequent application of vibrations to the connecting regions arranged in the stacked arrangement by the sonotrode.

Aside from a flawless connection of the connecting regions for the formation of weld nodes, it is also necessary for the quality of ultrasonically welded connections of this kind that the weld nodes meet specific geometrical requirements, which vary greatly depending on the type and size of the weld nodes.

For instance, in case of continuous weld nodes, which connect the connecting regions of conductors arranged in opposite directions, it is important that predefined distances between an end cross-section of a connecting region of a conductor extending in one direction and the sheath end surface of an insulating sheath of another conductor connected to the first conductor and extending in the opposite direction are observed. In case of a terminal weld node, which serves to connect a connecting region of a conductor with a connecting piece, also called a terminal in technical terminology, a predefined distance between the end cross-section of the conductor and a surface of the terminal arranged on the longitudinal axis of the conductor should be observed as well.

Defined distances are observed to ensure, among other things, that the connecting regions including the end cross-sections are compressed and welded together by the application of vibrations without allowing filaments or leads of the conductors to radially stick out because of an incomplete compression or welding of the connecting regions. Otherwise, filaments or leads radially sticking out might destroy the sheaths of adjacent conductors in a cable installation, which may cause short circuits.

Therefore, the object of the present invention is to provide a device of the kind described above that allows producing defined weld nodes between electrical conductors, thus increasing the reliability of cable installations.

To attain this object, the device according to the invention has the features of claim 1.

According to the invention, the device is provided with a compression space having a marking device for axial positioning of the connecting regions, said marking device comprising a radiation-emitting device interacting in a contactless manner with end cross-sections of the connecting regions in such a manner that the axial position of the end cross-sections within the compression space is defined in a third axial direction (x-axis) parallel to the working surface of the sonotrode by a position mark realized as a point of reflection or point of absorption of the radiation on the working surface of the sonotrode or the limiting surface of the limiting element.

Thus, according to the invention, the adjustment of a defined axial position of the end cross-section becomes possible without having to move the end cross-sections against an axial stop or the like. Instead, the end cross-section can be positioned by axially aligning the end cross-section relative to a reference mark or position mark. This position mark is produced by means of a radiation-emitting device in such a manner that the position mark is realized as an optically perceivable marking without having to form a mechanical stop or the like. The desired axial positioning of the end cross-section is thus achieved without having to move the end cross-section against a mechanical stop, i.e. in a contactless manner.

The terms point of reflection and point of absorption used here to describe the position mark should not be construed in a limiting manner to indicate a punctual design of a point of reflection or a point of absorption, but as a denotation of a geometrical place or region. Hence, the region of reflection or absorption can also have a linear shape or be an irregularly designed area.

The conductors welded together in the device according to the invention are usually rod-shaped conductors, i.e. conductors substantially determined in their dimension by their longitudinal extension, which additionally have an at least slight flexural stiffness so as to maintain their longitudinal extension despite their flexible nature as long as there is no radial load acting on the conductors. Conductors of this kind can be realized as an insulated stranded wire, for example, which, in particular if designed as a stranded wire and combined in stranded-wire packets made of a plurality of stranded wires, can be inserted into the compression space.

According to a preferred embodiment, a radiation-guiding device comprising at least one beam guide is arranged between the radiation-emitting device and the working surface of the sonotrode or the limiting surface of the limiting element in such a manner that a beam path defined by the beam guide and impinging upon the working surface of the sonotrode or the limiting surface of the limiting element serves to form the position mark arranged at a defined distance a from a side edge of the working surface of the sonotrode. Since a reference edge formed anyway by the side edge of the working surface is taken as a reference for adjusting the defined distance in addition to the position mark, no further adjustment or change of the compression space is necessary other than the installation of the radiation-emitting device and of the radiation-guiding device in order to realize the device.

It is particularly advantageous if the beam guide is realized in such a manner that the position mark extends linearly at a right angle to the third axial direction (x-axis) so that the end cross-sections of all connecting regions arranged on the working surface can be aligned at the linear position mark in particular in case of a stacked arrangement of connecting regions having several connecting regions arranged in one stacking plane, i.e. parallel to the working surface of the sonotrode.

If the beam guide is provided with a beam deflection device, the arrangement of the radiation-emitting device is independent of the point of reflection or point of absorption of the radiation forming the position mark, allowing the radiation-emitting device to be arranged in particular in a plane parallel to the working surface of the sonotrode and in a manner laterally offset from the compression space so that the emitting device does not adversely affect the accessibility of the compression space for inserting the conductors or the connecting regions of the conductors into the compression space.

It is particularly advantageous if the beam guide is realized as an optical waveguide, allowing the radiation-emitting device to be realized also as a separate device fully independent from the welding device and being connectable to the welding device via a coupling device. For this purpose, the use of an optic fiber cable as an optical waveguide is advantageous.

If the beam deflection device is preferably realized integrally in the beam guide, as is the case when a flexible optical waveguide, i.e. an optic fiber cable, is used, for example, the beam deflection device does not have to be designed as a device that is independent from the wave- guide. Alternatively, it is also possible of course to realize the beam deflection device as a prism so as to deflect a beam path impinging horizontally upon a refracting surface of the prism into a beam path. exiting the prism vertically and serving to form the position mark.

To achieve a particularly compact design of a combination of a compression space of the welding device and a radiation-emitting device serving to form the position mark, the radiation-emitting device can be arranged above the limiting element and opposite the slider element at a distance from the working surface of the sonotrode in such a manner that a beam path exiting the radiation-emitting device extends toward the beam deflection device arranged above the working surface of the sonotrode and the beam path exiting the beam deflection device impinges upon the working surface of the sonotrode so as to form the position mark.

If the radiation-emitting device has two beam guides forming two beam paths serving to form two position marks arranged at a defined distance a from the side edges of the working surface of the sonotrode and at a defined distance b from each other, end cross-sections of connecting regions of two conductors can be advantageously axially positioned, said conductors being welded together so as to form a continuous weld node of two conductors arranged opposite each other.

Independently of whether the device according to the invention is realized in such a manner that a welded connection formed as a continuous weld node is formed between axially positioned end cross-sections of connecting regions of conductors oriented opposite each other or whether the device according to the invention serves to form a welded connection realized as an end weld node between connecting regions of conductors extending parallel to each other, it is advantageous in any case if the radiation-emitting device serving to form the position marks is realized as a radiation source emitting optical radiation. The use of a laser radiation source as a radiation source proves particularly advantageous owing to the high beam density and the thus possible particularly high-contrast formation of the position mark.

In the following description, preferred embodiments of the device will be explained in more detail with the aid of the drawing.

In the drawing:

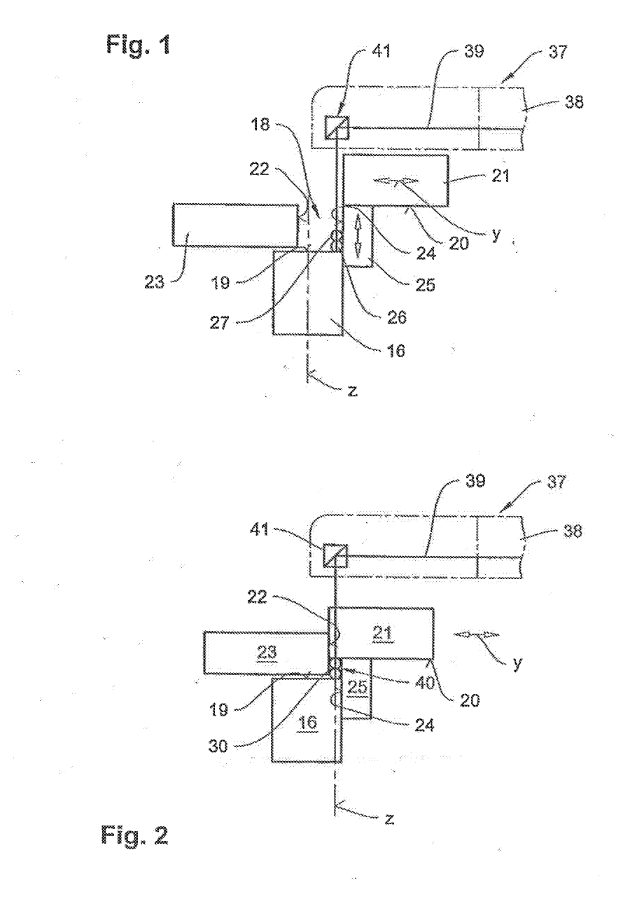

FIG. 1: shows a front view of an open compression space of an ultrasonic welding device with two connecting regions of conductors to be welded together being arranged one on top of the other in a stacked arrangement;

FIG. 2: shows the compression space illustrated in FIG. 1 in the closed configuration;

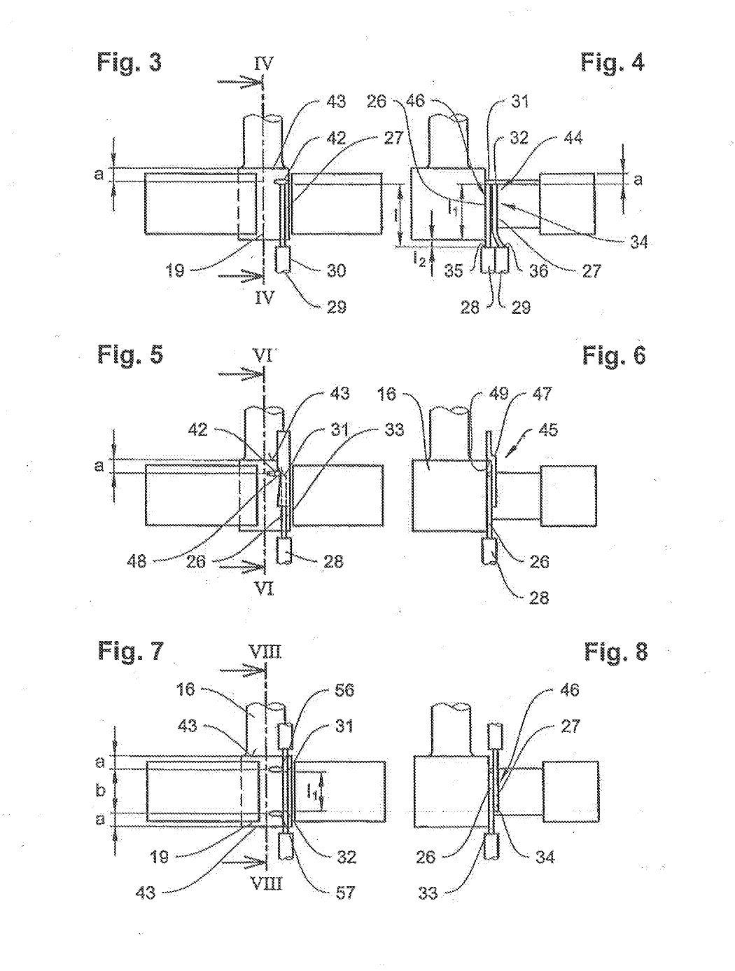

FIG. 3: shows the compression space according to FIG. 1 in a top view with two conductors arranged one on top of the other in a stacked arrangement and in the same direction for the formation of an end weld node;

FIG. 4: shows the compression space illustrated in FIG. 3 in a sectional illustration along section line IV-IV;

FIG. 5: shows the compression space illustrated in FIG. 1 in a top view including the illustration of a connecting region of a conductor arranged on a terminal for the formation of a terminal weld node;

FIG. 6: shows the compression space illustrated in FIG. 4 in a sectional illustration along section line VI-VI;

FIG. 7: shows the compression space illustrated in FIG. 1 in a top view including connecting regions of two conductors arranged in the opposite sense and one overlapping the other in a stacked arrangement for the formation of a continuous weld node;

FIG. 8: shows the compression space illustrated in FIG. 7 in a sectional view along section line VIII-VIII;

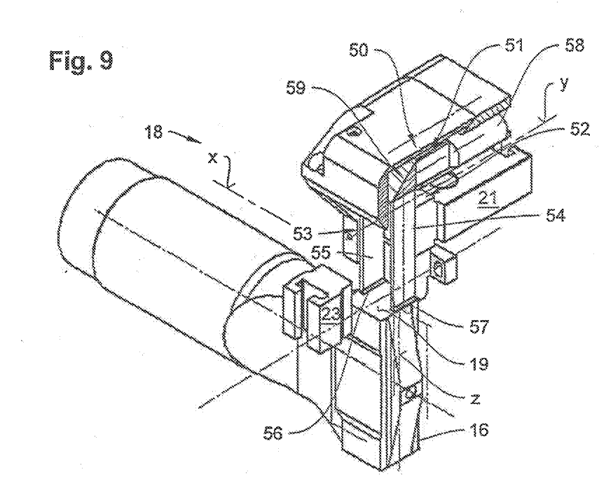

FIG. 9: shows a compression space and a radiation-emitting device in an isometric illustration; and

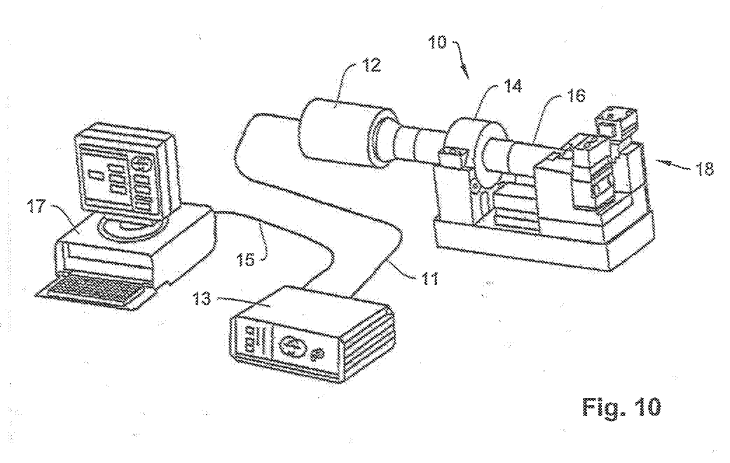

FIG. 10: shows a principal illustration of an ultrasonic welding device including periphery.

FIG. 10 shows the basic arrangement of components of an ultrasonic welding device 10 comprising a converter 12, a booster 14 and a sonotrode 16. As illustrated in particular in FIG. 1, the sonotrode 16 or an opposing electrode 21 associated therewith limit a compression space 18 in a first axial direction (z-axis), said compression space 18 being adjustable in height and width so as to be able to adjust the cross-section of the compression space 18 to the number or the cross-section of the In conductors to be welded together. The converter 12 is connected to a generator 13 via a cable 11, and the generator itself is connected to a computer 17 via a cable 15 to input welding parameter or the cross-section geometry of the conductors to be welded together. The power output of the generator 13 can then be determined to retrieve the required welding parameters by means of a program stored in the computer 17 and to correspondingly generate ultrasonic vibrations by means of the converter 12, which are transmitted to the sonotrode 16 or to the working surface 19 (FIG. 1) of the sonotrode 16 via the booster 14.

FIGS. 1 and 2 show the substantial elements of the compression space 18, whose cross-section can be adjusted, i.e., whose height and width can he adjusted in the embodiment examples. The compression space 18 is limited in the first axial direction (z-axis) at two opposing sides by a working surface 19 of the sonotrode 16 transmitting ultrasonic vibrations and by an opposing surface 20 of an opposing electrode 21 displaceable in a second axial direction (y-axis). In the second axial direction, which is illustrated in FIGS. 1 by the y-axis, the compression space 18 is limited at two opposing sides by a limiting surface 22 of a slider element 23 displaceable in the direction of the y-axis and by a limiting surface 24 of a limiting element 25 displaceable in the direction of the z-axis in the same way as the opposing electrode 21.

In the embodiment of the compression space 18 illustrated in FIG. 1, two connecting regions 26, 27 of conductors 28, 29 to be connected together by an ultrasonically welded connection are arranged one overlapping the other in a stacked arrangement on the working surface 19 of the sonotrode 16, FIG. 1 showing the connecting regions 26, 27 immediately after their insertion into the open compression space 18.

FIG. 2 shows the compression space 18 in the closed configuration, in which the components limiting the compression space 18, i.e. the sonotrode 16, the opposing electrode 21, the slider element 23 and the limiting element 25, are moved up against one another in such a manner that the compression space 18 now reduced in volume forms a cavity 40 that allows compressing and connecting the connecting regions 26, 27 in a friction-welding process to form a weld node when mechanical vibrations of the sonotrode 16 are applied to the connecting regions 26, 27 of the conductors 28, 29.

The stacked arrangement of the connecting regions 26, 27 of the conductors 28, 29 illustrated in FIG. 1 can be produced by aligning the conductors 28, 29 in the same direction as illustrated in FIGS. 3 and 4, wherein the blank regions 33, 34 of the conductors 28, 29 free of an insulating sheath 30 are inserted far enough into the compression space 18 in the direction of the x-axis that the distance a at which the end cross-section 31, 32 of the conductors 28, 29 are located from a side edge 43 of the working surface 19 becomes a predefined length l₁ of the connecting regions 26, 27. The length l of the blank regions 33, 34 is selected in such a manner that a usually also predefined distance l₂ remains between the connecting region 26, 27 and an axial sheath end surface 35, 36.

To allow for a corresponding axial positioning of the end cross-sections 31, 32 of the conductors 28, 29 in the open compression space 18, the compression space 18 is provided with a marking device 37, which is schematically illustrated in FIG. 1 and comprises a radiation-emitting device 38. As becomes clear from a combined view of FIGS. 1 and 2, the radiation-emitting device 38, which is a laser radiation source in the case of the present embodiment example, emits laser radiation along a beam path 39, which is deflected in the direction of the z-axis by a beam deflection device 41 in the embodiment of the marking device 37 illustrated in FIG. 1 and impinges upon the working surface 19 of the sonotrode 16 in a point of reflection forming a position mark 42.

In order to form a defined beam path 39, the beam path 39 can be adjusted by means of the beam deflection device 41 or by means of a radiation-guiding device comprising the beam deflection device 41, such as a fiber optic cable (not illustrated), in such a manner that the position mark 42 is formed at the point on the working surface 19 of the sonotrode 16 that defines the desired distance a between the side edge 43 and the end cross-sections 31, 32 of the conductors 28, 29. In practice, this means that an operator who inserts the blank regions 33, 34 of the conductors 28, 29 into the open compression space 18 merely has to axially position the end cross-sections 31, 32 of the blank regions 33, 34 on the working surface 19 of the sonotrode 16 in such a manner that the end cross-sections 31, 32 are located at the position mark 42 so as to ensure that the weld node formed between the conductors 28, 29 by welding exhibits the required node geometry having the length l₁ of the connecting regions 26, 27 and the distance l₂ between the connecting regions 26, 27 and the sheath end surface 35, 36.

As can be taken from FIGS. 5 and 6 as well as 7 and 8, the marking device 37 is generally suitable not only for use in the production of an end weld node 44 as illustrated in FIGS. 3 and 4 but also for the production of a terminal weld node 45 as illustrated in FIGS. 5 and 6 and of a continuous weld node 46 as illustrated in FIGS. 7 and 8.

When producing the terminal weld node 45 illustrated in FIGS. 5 and 6, the end cross-section 31 of the conductor 28 is axially aligned at the position mark 42 in the same manner as explained above with reference to FIGS. 3 and 4. Moreover, a terminal 47 is arranged in a stacked arrangement on the blank region 33 of the conductor 28, the terminal 47 being provided with a marking 48, which is formed by an indentation in this case and can be made to cover the position mark 42. Of course, suitable markings can also be formed by embossed lines or other optically noticeable features. In the case in which a terminal weld node 45 is produced between a terminal 47 and a conductor 28, the marking device 37 thus also allows producing a weld node having a defined geometry and having the end cross-section 31 of the connecting region 26 at a defined distance a from an opposing surface 49 of the terminal arranged flush with the side edge 43 of the working surface 19 of the sonotrode 16. In this way, a deformation by compression of the end cross-section 31 against the opposing surface 49 during the application of vibrations to the connecting region 26 by the sonotrode 16 is precluded.

In the axial positioning of the end cross-sections 31, 32 of the conductors 28, 29 illustrated in FIGS. 7 and 8, the conductors are arranged in the opposite direction, meaning the conductors 28, 29 do not extend parallel to each other, as is the case in the embodiment example illustrated in FIG. 2, but in opposite directions so as to form a continuous weld node between the conductors 28, 29.

The use of a marking device 50 for forming the continuous weld node 46 is shown in FIG. 9 in an isometric illustration. The marking device 50 comprises a radiation-guiding device 51 having two beam guides 52, 53, each of which defines a beam path 54, 55, each beam path 54, 55 allowing a position mark 56, 57 to be formed on the working surface 19 of the sonotrode 16.

As illustrated in FIG. 9, the marking device 50 comprises two radiation-emitting devices 58, each of which generate the beam path 54, 55. Each of the beam paths 54, 55 is deflected onto the z-axis by a beam deflection device 59. The radiation-emitting devices 58 are located above the opposing electrode 21 of the compression space 18 and opposite the slider element 23 in such a manner that the beam paths 54, 55 generated by the radiation-emitting devices 58 in the horizontal direction (y-axis) are deflected into the vertical direction (z-axis) by the beam deflection device 59 so as to each impinge onto the working surface 19 of the sonotrode 16 in a point of reflection to form the position marks 56 and 57.

As becomes clear from a combined view of FIGS. 7, 8 and 9, a suitable adjustment of the distance between the beam paths 54 and 55 by means of an adjusting device (not illustrated), by which the radiation-emitting devices 58 and the beam deflection devices 59 are displaced parallel to one another in the direction of the x-axis, for example, allows adjusting both a defined distance b between the position marks 56, 57 on the working surface 19 of the sonotrode 16 and a defined distance a between the position marks 56, 57 and the side edges 43 of the working surface 19, resulting in an exactly defined length for the connecting regions 26, 27 of the blank regions 33, 34 arranged in a stacked arrangement one on top of the other once the end cross-sections 31, 32 of the conductors 28, 29 are axially aligned to the position marks 56, 57.

1. A device for welding rod-shaped electrical conductors the device comprising:
a compression space for receiving two connecting regions of conductors to be connected to each other, the compression space being limited in a first axial direction (z-axis) at two opposing sides by a working surface of a sonotrode transmitting ultrasonic vibrations in the first axial direction and by an opposing surface of an opposing electrode and in a second axial direction (y-axis) at two opposing sides by a limiting surface of a slider element displaceable in the second axial direction and by a limiting surface of a limiting element; and
a marking device for axial positioning of the connecting regions, the marking device including a radiation-emitting device interacting in a contactless manner with end cross-sections of the connecting regions in such a manner that an axial position of the end cross-sections within the compression space is defined in a third axial direction (x-axis) parallel to the working surface of the sonotrode by a position mark, the position mark being a point of reflection or point of absorption of the radiation on the working surface of the sonotrode or on the limiting surface of the limiting element.

2. The device according to claim 1, in which a radiation-guiding device including at least one beam guide is arranged between the radiation-emitting device and the working surface of the sonotrode or the limiting surface of the limiting element in such a manner that a beam path defined by the beam guide and impinging upon the working surface of the sonotrode or upon the limiting surface of the limiting element, said beam path forming the position mark arranged at a defined distance-a from a side edge of the working surface of the sonotrode.

3. The device according to claim 2, in which the the position mark extends linearly at a right angle to the third axial direction.

4. The device according to claim 2, in which the beam guide includes a beam deflection device.

5. The device according to claim 2, in which the beam guide is an optical waveguide.

6. The device according to claim 5, in which the beam deflection device is integrally with the beam guide.

7. The device according to claim 1, in which the radiation-emitting device is arranged above the limiting element and opposite the slider element at a distance from the working surface of the sonotrode, that a beam path exiting the radiation-emitting device extends toward the beam deflection device arranged above the working surface of the sonotrode and the beam path exiting the beam deflection device impinges upon the working surface of the sonotrode so as to form the position mark (12, 56, 57).

8. The device according to claim 2, in which the beam deflection device includes two beam guides forming two beam paths serving to form two position marks arranged at a defined distance a from the side edges of the working surface of the sonotrode and at a defined distance b from each other.

9. The device according to claim 1, in which the radiation-emitting device is a radiation source emitting optical radiation.

10. The device according to claim 9, in which the radiation source is a laser radiation source.
